(19) United States
(12) Patent Application Publication
(10) Pub. No.: US 2026/0023566 A1
(43) Pub. Date: Jan. 22, 2026

(54) HARDWARE IMPLEMENTED CODEBOOK POINTERS

(71) Applicant: Taalas Inc., Toronto (CA)

(72) Inventor: Ljubisa Bajic, Toronto (CA)

(21) Appl. No.: 19/274,284

(22) Filed: Jul. 18, 2025

Related U.S. Application Data
(60) Provisional application No. 63/673,669, filed on Jul. 19, 2024.

(51) Int. Cl. G06F 9/34; G06F 9/30

(52) U.S. Cl. CPC G06F 9/34; G06F 9/3013

(57) ABSTRACT

Methods and systems that involve computer architectures are disclosed herein. Methods and systems are disclosed for hardware implemented pointers to store and modify large data structures such as the network data used in artificial intelligence applications. The data in a large data structure (e.g., a large data set) can be stored using hardware implemented pointers in the form of a configurable connectivity mesh or a set of readable cells storing a set of addresses. A set of registers storing a set of values for the variables in the large data structure can be connected to the configurable connectivity mesh or the set of readable cells. The large data set can be modified by changing the values stored in the set of registers.

### CROSS REFERENCE TO RELATED APPLICATION

This application claims the benefit of U.S. Provisional Patent Application No. 63/673,669, titled “Hardware Implemented Codebook Pointers,” and filed on Jul. 19, 2024, the entire content of which is incorporated by reference herein.

### TECHNICAL FIELD

This disclosure relates to computational architectures, in particular, to utilizing hardware implemented pointers to store and modify large data structures.

### BACKGROUND

Machine learning is experiencing a remarkable surge in importance within our society. Businesses are leveraging the capabilities of machine learning to extract actionable insights from vast datasets, automate tasks, and predict future trends with unprecedented accuracy. This transformative technology provides companies with a significant competitive advantage and drives broader economic benefits such as improved efficiency, increased productivity, etc. However, the rapid growth in machine learning has led to massive increases in the demand for computational resources.

One challenge is the burden of escalating computational costs in machine learning applications. As machine learning models become more complex and datasets expand, the associated computational resources escalate. Training deep neural networks, for instance, can require immense processing power and memory, often pushing the limits of available hardware. This increased cost affects the affordability of training models, raises environmental concerns due to heightened energy consumption, and further creates a barrier to entry for smaller organizations and researchers with limited resources. To address this challenge, more efficient algorithms, software techniques to increase parallelization, hardware acceleration, and numerous other approaches can be employed.

Another major challenge in modern machine models is the efficient storage and manipulation of the vast number of parameters that define these models. As used herein, the terms “network data” and “parameters that define a model” are used interchangeably. Both refer to the data that characterizes the feature and functionality of a machine learning model or artificial intelligence system. The scale and complexity of contemporary models, especially those used in natural language processing and computer vision, can have billions or even trillions of parameters. Storing these massive models requires substantial memory resources, often necessitating specialized hardware such as graphics processing units (GPUs) or tensor processing units (TPUs) with high memory capacities.

Beyond storage, efficiently managing and accessing the vast amount of data poses additional difficulties. For example, increased latency and reduced performance during training or inference are common issues. While compression techniques and distributed storage solutions can help mitigate these issues, they bring new complexities and introduce trade-offs such as potential loss of precision and increased computational overhead.

Hence, it is desirable to develop a novel system and method to balance the need for high-capacity storage, rapid accessibility, and efficient computation in the design, deployment, and maintenance of modern machine learning models.

### SUMMARY

Methods and systems that involve computational architectures are disclosed herein. Specifically, methods and systems that include computational architectures for using hardware implemented pointers in the storage and modification of large data structures are disclosed herein. In some embodiments, the large data structures may be the network data of a machine learning model. The large data structures can comprise a set of variables, where each variable represents a parameter of a machine learning model, and the value of each variable reflects the value assigned to that parameter.

The large data structures may be stored and modified using hardware implemented pointers. In some embodiments, hardware implemented pointers can be in the form of a configurable connectivity mesh or a set of readable cells for storing a set of addresses that can be applied to a downstream circuit (e.g., a multiplexer). These hardware implemented pointers can be employed in conjunction with a set of registers, where the registers store a set of values of the variables in the large data structure and are connected to the configurable connectivity mesh or the set of readable cells. The hardware implemented pointers together with the set of registers can function as a code book to define how encoded values (e.g., in the readable cells) correspond to actual data value (e.g., in the registers) for the data structure, which will be further described below in FIGS. 1-3.

In some embodiments, a large data structure stored according to the approaches disclosed herein can be dynamically modified, for example, by updating the values stored in a set of registers as described above. These registers correspond to a defined set of variables representing the content of the large data structure. In some embodiments, the set of values for the variables in the large data structure in the registers may encompass every potential value that the variables in the data structure are capable of having. Notably, in many cases, the number of potential (unique) values that variables can take in a large data structure may be several orders of magnitude smaller than the total number of variables in the large data structure. This characteristic can be exploited to achieve substantial efficiency gains: by modifying only the relatively small set of values in the registers, rather than the entire data structure. Therefore, updates or manipulations can be performed more rapidly and with lower computational overhead.

In some embodiments, the set of values for the variables in the large data structure may vary in terms of bit width (number of bits). For example, some variables may be represented using fewer bits than others, depending on the precision or range required for a given context. This variability enables further optimization in memory usage and processing efficiency, offering a flexible and scalable approach to handling large-scale data structures in hardware implementations.

Disclosed herein includes systems for using hardware implemented pointers to store and modify large data structures. In some embodiments, the system comprises a set of registers storing a set of values, a set of readable cells storing a set of addresses, a read circuit coupled to read from the set of readable cells, and a selection circuit. The selection circuit is coupled to receive input from the set of registers, coupled to receive control from the read circuit, and configured to generate a set of outputs using the set of values from the set of registers based on the set of addresses from the read circuit.

In other embodiments, the system comprises a set of registers storing a set of values, a set of readable cells, a configurable connectivity mesh coupling the set of registers to the set of readable cells, and a read circuit that is read-coupled to the set of readable cells and that is configured to provide a set of outputs using the set of values as provided from the set of registers to the set of readable cells via the configurable connectivity mesh.

Disclosed herein includes methods for using hardware implemented pointers to store and modify large data structures. In some embodiments, the method comprises storing a set of values in a set of registers, storing a set of addresses in a set of readable cells, configuring a set of hardware implemented pointers to map the set of registers to the set of readable cells, and reading the set of readable cells using a read circuit to obtain a set of outputs from the set of registers through the set of hardware implemented pointers.

In some embodiments, the set of hardware implemented pointers is implemented using a configurable connectivity mesh or the set of addresses stored in the set of readable cells.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an exemplary block diagram of hardware pointers implemented as a set of stored addresses stored in a set of readable cells, according to some embodiments.

FIG. 2 illustrates an exemplary block diagram of hardware pointers implemented as a configurable connectivity mesh, according to some embodiments.

FIG. 3 illustrates a data flow diagram showing the manipulation of a set of values of variables in a large data set by modifying a quantization of the variables in the large data set, according to some embodiments.

FIG. 4 illustrates a flow diagram for storing variables of a large data structure using hardware implemented pointers, according to some embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

Methods and systems that include computational architectures for using hardware implemented pointers in the storage and modification of large data structures are disclosed herein. As disclosed in the summary above, hardware implemented pointers in conjunction with an associated set of registers can form or function as a code book for a large data structure, enabling the efficient storage and subsequent manipulation of the values assigned to the variables of the data structure. In some embodiments, the hardware implemented pointers can be implemented using a configurable connectivity mesh or a set of addresses stored in a set of readable cells. Accordingly, the set of registers may store the values of the variables in the large data structure, and the pointers can identify the value of each variable by referencing the appropriate registers in the set of registers that store those values. The pointers can be arranged physically or logically in accordance with the data structure, allowing the values of the data structure to be accessed using the pointers.

In some embodiments, different portions of the data structure can be accessed by providing different addresses to a read circuit coupled to read from the set of readable cells. The set of registers can store all the potential values that the variables in the data structure may take. The different addresses provided to the read circuit can be physically or logically associated with all of the variables in the data structure. While the term “registers” is used throughout this disclosure as an example, any form of computer-readable media or storage means can be used in place of the registers.

The set of registers can be configured to store all the potential values of the variables of the data structure. By modifying the values stored in the set of registers, the values of the corresponding variables in the data structure can be updated accordingly. The values in the set of registers can be modified to reflect a wide range of variable changes. For example, the numerical or logical value of the variables in the data structure can be changed, thereby directly altering the represented data. The data type used to represent the variables of the data structure can be altered, for instance, by switching from a floating point to an integer representation. The resolution or number of bits used to represent the variables of the data structure can be adjusted, for instance, by transitioning from a 4-bit to a 16-bit format. The quantization/mapping scheme applied to the variables in the data structure can also be changed, thereby modifying how continuous values are approximated or grouped. Based on the modifications of register values, other modifications or transformations may also be applied to affect how the variables in the data structure are implemented or interpreted. The approach disclosed herein allows for highly flexible and efficient data manipulation, enabling system-level updates to large data structures by simply updating the contents of a set of registers rather than rewriting the entire data structure.

Alternatively or additionally, different parts of the set of registers can be referenced by the hardware implemented pointers in order to modify the values of the variables in the data structure (e.g., a large data structure). In some embodiments, the set of addresses can be translated by a configurable translation logic. As a result, this translation logic may associate a first register from the set of registers with an address in one configuration, while associating a second register from the set of registers with the same address in a different configuration. Instead of modifying the values stored in the set of registers, the configuration of the variable translation block logic can be used to modify the values of the set of variables in the data structure. In other words, the value associated with a variable in the data structure can be adjusted simply by reconfiguring the translation logic, without rewriting the actual register contents.

A connectivity mesh refers to a configurable network of interconnections that determines how different components (e.g., registers, memory cells, or processing elements) are linked together to enable data routing and access. Here, a connectivity mesh allows each readable cell in the set of readable cells to be coupled to a register in the set of registers. In some embodiments, the connectivity mesh may be configurable. Alternatively, the connectivity mesh may be connected to an auxiliary connectivity mesh, which enables more flexible reconfiguration than the connectivity mesh. For example, the connectivity mesh may be implemented by one-time-programmable connection states, making it more permanent and stable, while the auxiliary connectivity mesh may be implemented using electrically reprogrammable connections, offering more dynamic control. Based on this arrangement, the disclosed system can alter which registers from the set of registers are connected to a given shared node of the connectivity mesh, where the shared node acts as a switching or routing point to determine which register (and therefore which variable's value) a readable cell can access. Accordingly, instead of modifying the values stored in the set of registers, the configuration of connectivity mesh or auxiliary connectivity mesh can be changed to connect to different variables. For example, a connection to a register storing a 4-bit representation of a value may be substituted by a connection to a register storing a 16-bit representation of the same or a different value, thereby adapting the data structure's resolution or encoding format without directly altering the register contents. The reconfigurable mechanisms disclosed herein offer efficient and flexible strategies for managing complex and dynamic data structures in hardware.

The systems disclosed herein can be implemented in circuitry. The disclosed systems can be implemented as an integrated circuit or one or more integrated circuits that are in communication with each other. In some embodiments, the disclosed systems may include matrix multiplication accelerators. The disclosed systems may include a controller such as a central processing unit, microcontroller, control circuit, or other types of controller. The controller is capable of modifying the values in the set of registers, configuring the hardware implemented pointers, providing addresses to the read circuit, and accessing the readable cells in order to access the data structure.

The hardware implemented pointers can be arranged either physically or logically in accordance with the data structure so that the values of the data structure can be efficiently accessed. In some embodiments, the hardware implemented pointers may take the form of either (1) a configurable connectivity mesh that dynamically connects to different hardware elements (e.g., a set of readable cells, registers) or (2) a set of addresses stored in a set of readable cells that control access paths through a read circuit. In both implementations, efficiency can be achieved by associating the arrangement of the readable cells with an arrangement of the data structure. The readable cells will thereby be associated with variables of the data structure, in that the organization of the readable cells reflects the organization of the variables in the data structure they represent.

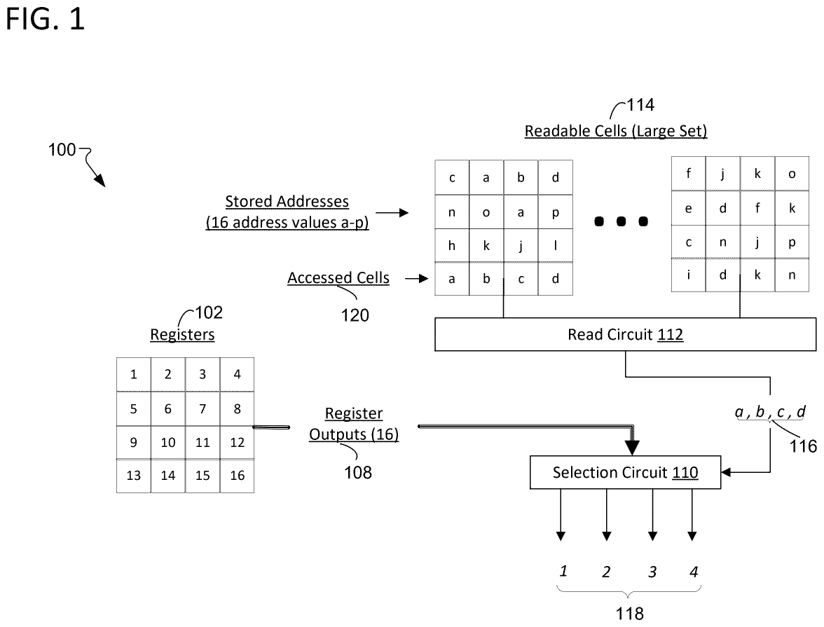

For example, if the data structure is a 4-by-X matrix, the set of readable cells (e.g., 114 in FIG. 1 below) may be arranged in a corresponding 4-by-X configuration. In this setup, each cell is associated with a specific variable (e.g., a specific matrix element) from the 4-by-X data structure. In practice, it is not necessary for the physical dimensions of the set of readable cells to be matched to the dimension of the data structure (represented by the values stored in the set of readable cells). The association between cells in the set of readable cells and variables in the data structure can be implemented through the logic of a read circuit (e.g., 112 in FIG. 1 below) and the corresponding controllers, which interpret cell positions and correctly map the cells to the logical structure of the data. This enables hardware flexibility even if the readable cells are physically laid out differently from the data structure. However, in some cases, the position of a readable cell in the set of readable cells may correspond with (directly reflect) the position of a variable in the data structure.

In some implementations, the number of readable cells may be configured to be equivalent to the number of variables in a large data structure. For example, in neural networks that use tensors to represent billions of parameters or network data, each parameter or variable may have a dedicated readable cell. In this case, the number of readable cells in an integrated circuit implementation can be on a giga-scale, and the readable cells are uniquely associated with the billions of variables. This creates a one-to-one correspondence between the set of readable cells and the variables in the data structure. Notably, the readable cells are not associated directly with the values for the variables but, instead, are associated with the variables themselves. In other words, the readable cells do not store the actual values of the variables but store pointers or addresses that indirectly reference the values stored in a separate set of registers. This abstraction allows efficient reconfiguration and memory reuse, since each readable cell may serve as a handle for accessing or updating the variable represented by the cell. The readable cells are each associated with an entry/variable of the data structure and are ordered to match the order of the entries in the data structure, which preserves the logical layout even if the values themselves are shared across many variables.

The cardinality of the set of registers (e.g., 102 in FIG. 1 below) can be configured to be different values in different applications. These registers store the values of variables in the data structure, and the number of registers can vary based on the data representation needs.

In some embodiments, the set of registers can be associated with every potential value in a data structure in a one-to-one correspondence. For example, in a data structure with 1,000 variables and 57 unique values assigned to these variables, the set of registers may include 57 registers with each register being uniquely associated with one of the 57 unique values. In this case, the registers are configured to store only the distinct values present in the data structure.

In other embodiments, the set of registers can be associated with every potential value of a variable in a data structure. For example, in a data structure with one trillion variables where each variable is one of 50,000 unique values, 50,000 registers may be used with each register being associated uniquely with one of the 50,000 unique values. Here, the set of registers corresponds to every possible value that a variable may take.

In some embodiments, the set of registers may include a register for every potential value of the variables as set by the resolution of the data type used to represent the variables. For example, if the variables were represented by a 4-bit data type, there may be a set of 2⁴=16 registers. If the variables were represented by a 16-bit data type, there may be a set of 2¹⁶=65,536 registers. The number of registers is determined based on the bit-width of the data type. When the variables in a data structure are n-bit values, the set of registers has a cardinality of two to the n power (2ⁿ). In some embodiments, the variables in the data structure can be represented by different data types at different times, and the set of registers can have a cardinality of 2^{x}, where x is the number of bits used to represent the largest data type that can be used to represent the variables in the data structure. In other words, the number of registers can be scaled dynamically to accommodate the largest supported data type when multiple data types are supported. For example, if the data types can be switched between 8-bit and 16-bit, the disclosed system may provision for up to 2¹⁶ registers. This flexible architecture enables hardware reuse and optimization. A smaller, quantized model may use fewer registers and allow faster access, while a higher-resolution model can access more precise values. Using this implementation, the set of registers can have a configurable cardinality, meaning that the number of active registers can be adjusted at running time depending on the particular data structure that the system is being configured for or based on the particular data type that is being used to represent the values of the variables.

The readable cells can take on various characteristics in different applications. The readable cells can be implemented in read only memory (ROM), programmable read only memory (PROM), electrically erasable programmable read only memory (EEPROM), flash memory, cross-point memory, random access memory (RAM), static random access memory (SRAM), magneto-resistive random access memory (MRAM), mask ROM, or any kind of memory. The readable cells can be registers, latches, or flip-flops.

In some embodiments, the set of readable cells may be configured to support parallel reading, where the addresses stored in the readable cells and associated with the variable/parameter values can be read concurrently and resolved by a selection circuit. For example, the readable cells may each be associated with a variable from a data structure. The readable cells can be gathered in subsets of readable cells, where each subset of readable cells represents all the values of a variable. Multiple subsets of readable cells may be grouped to form a larger set of readable cells that represents a data structure. Additionally, the readable cells may be part of a set of readable cells that defines all the available readable cells in a given integrated circuit or a particular block of circuitry in a given integrated circuit. For example, a particular block of circuitry may include an array of readable cells, which is of a dimension with one billion readable cells by 1,000 readable cells (i.e., 1 billion by 1,000 matrix) to store a data structure having a trillion variables/parameters. This scale is consistent with high-capacity neural network hardware, where billions to trillions of parameters may be accessed in parallel during inference or training. Furthermore, the readable cells may be distributed in various layouts relative to the set of registers and other components of the systems disclosed herein.

The individual readable cells can be configured in various ways in different applications. In some embodiments, the readable cells can be configured similarly to ROM cells. In some embodiments, the readable cells may include an access transistor and a programmed value. The access transistor, such as an N-channel metal-oxide-semiconductor (NMOS) or a P-channel metal-oxide-semiconductor (PMOS), may be used to control the flow of current and provide selective access to storage elements. The programmed value represents the address of a register storing a variable value. When the access transistor is conductive, the value may be passed through the access transistor and read out by a read circuit. When the access transistor is not conductive, the same read circuit may read a different value. The control node of the access transistor can be connected to a word line. A drain or source node of the access transistor can be coupled to the programmed value. The alternative drain or source node of the access transistor can be coupled to a bit line. The bit line can be connected to the read circuit. The readable cell can be read by activating the word line and bit line associated with the access transistor. When a word line is activated, an access transistor conducts and allows a programmed value to be passed through a bit line to a read circuit, which interprets the stored address. If the word line is not activated, the access transistor remains off, preventing the cell's value from interfering with the reading of other cells. This design allows multiple cells to share the same read circuitry efficiently, and only the activated cells contribute to the output.

The readable cells can be in compliance with those described in U.S. Provisional Patent Application No. 63/619,662, as filed on Jan. 10, 2024, and incorporated by reference herein in its entirety for all purposes.

In some embodiments, the set of readable cells can be addressable by a read circuit. The read circuit can address specific cells or subsets of cells (e.g., by activating associated word lines), enabling access to stored data. The read circuit can then retrieve the stored data and forward the data to downstream circuits for further processing (e.g., providing values to a computation logic). Depending on the system configuration and design objectives, the read circuit may be used to retrieve addresses or direct values. The read circuit may extract addresses associated with a given data structure from the readable cells and use the addresses to select values from a set of registers. In this way, the disclosed system supports memory indirection and reduces redundancy when multiple variables share common values. Alternatively, the readable cells themselves may store variable values directly, and the read circuit may directly retrieve the values for a given data structure from the readable cells.

The disclosed system allows for parallel access to subsets of readable cells, enabling high-throughput data operations. In some embodiments, the read circuit may address a given subset of readable cells to read a portion of the data structure variables in parallel. For example, the read circuit may be configured to read a first subset of the set of readable cells associated with a first word line independently, and read a second subset of the set of readable cells associated with a second word line independently. The configuration of the read circuit may resemble the methods used in standard ROM, RAM, or flash memories, where different sets of memory cells are typically connected to a word line and can be accessed either in parallel or individually using a bit line selection mechanism. The disclosed system enables independent and concurrent reading of multiple groups of data, which is important for applications (e.g., deep neural networks or tensor operations) where large amounts of structured data are accessed simultaneously (e.g., per layer, per neuron, or per batch).

When the pointers are implemented by sets of addresses stored in a set of readable cells, the addresses can refer to the addresses of the registers. For example, if the set of registers were a set of 16 registers, the set of addresses may be a set of 16 addresses with each address in the set of addresses referring to a register in the set of registers. The set of addresses can be associated with a set of values of the set of variables in an address space. The address space can be the address space of a selection circuit, such as a multiplexer. When an address from the set of addresses is applied to the control input of the selection circuit, the selection circuit selects the value stored by a register from the set of registers that is associated with the applied address and passes the selected value to an output of the selection circuit.

In some embodiments, the selection circuit can be input-coupled to the outputs of a set of registers, control-coupled to a read circuit, and output-coupled based on the address space. Therefore, the registers that store variable values are connected to input lines of the selection circuit, and the read circuit determines which input (e.g., which register value) should be passed to the output. Once an address is received and a register is selected, the selected value is forwarded to the output line of the selection circuit. In some embodiments, the read circuit can be read-coupled to the set of readable cells, such that the read circuit can access and retrieve the addresses stored in the set of readable cells. This enables the dynamic selection and output of variable values from the registers based on the content of the readable cells.

The configurability of the set of addresses stored in the set of readable cells may allow the disclosed system to serve as a computational structure for specific data structures. For example, the model/network data (e.g., parameters, weights) of a machine intelligence application can be mapped into a set of addresses and stored in a set of readable cells such that the disclosed system is customized to that model. Since the model data typically does not change after model training, a trained model can be deployed into the disclosed system by writing the configuration or model data of the model into the readable cells. This hardware implementation for inference provides an efficient means for executing the model. Yet the disclosed system remains reconfigurable. A different trained model can be deployed by simply replacing the address stored in the set of readable cells with a new set of addresses associated with the different model, without modifying other portions of the disclosed system.

In some embodiments, mask ROM approaches can be used to configure the set of addresses stored in the set of readable cells. For example, different high level metal wiring masks can be customized to encode different address configurations of a specific model. Modifying a system for a specific model may require saving the model in the mask ROM during the fabrication of the integrated circuit, offering both space efficiency and performance benefits for that model.

### System Implementation

### Hardware Pointers-Readable Cells Storing Addresses

In some embodiments, the hardware implemented pointers disclosed herein may be in the form of addresses stored in readable cells that control access paths through a read circuit. FIG. 1 provides an exemplary block diagram 100 of hardware pointers implemented as a set of addresses stored in a set of readable cells. These pointers along with a set of registers can be used to provide a code book for a large data structure. As depicted, the disclosed system 100 includes at least a set of registers 102, a selection circuit 110, a read circuit 112, and a set of readable cells 114. In this example, the set of registers 102 stores 16 potential values assigned to variables of a data structure. Selection circuit 110 is input-coupled to the set of registers 102 and control-coupled to the output of read circuit 112. That is, selection circuit 110 has data input from register outputs 108 and control input from read circuit 112. Register outputs 108 are inputted to selection circuit 110, which, under the control of read circuit 112, may generate an output (e.g., output 118). This output is in the form of the values of the variables of a data structure that are associated with the set of readable cells 114. The readable cells 114 store a set of 16 address values and can be accessed by read circuit 112. Read circuit 112 may read a set of readable cells 114 and provide the control to the selection circuit 110.

The readable cells may store a set of addresses. In some embodiments, the set of readable cells 114 can store a set of addresses that are associated with the values of the variables of the data structure in an address space. In the illustrated example, the addresses are values “a” to “p” in readable cells 114, which are in a one-to-one correspondence with the numerical values “1” to “16.” For example, the address “b” may be associated with a value of “2.” The address space is used by selection circuit 110 to select, from register outputs 108, the inputs that are associated with the addresses. In the illustrated example, the addresses “a, b, c, d” in 116 are being read from memory (e.g., accessed cells 120) and applied to selection circuit 110. Accordingly, selection circuit 110 can select the register outputs 108 (e.g., values from the set of registers 102) associated with values “1, 2, 3, and 4.” As a result, the outputs from selection circuit 110 are the values “1, 2, 3, 4” in 118.

Using this approach, the disclosed system enables efficient and flexible access to the values of variables in a large data structure by employing hardware implemented pointers, such as addresses stored in a set of readable cells. By repeatedly reading different addresses from readable cells 114, the hardware implemented pointers allow the disclosed system to dynamically access any of the values of the variables in the data structure.

A significant benefit of the hardware implemented pointers is that the disclosed system can modify all the values of the variables in the data structure by merely changing the values in the set of registers 102 instead of changing all the values stored in the set of readable cells 114. Since these registers 102 are referenced indirectly through hardware pointers (addresses), updating the register values automatically reflects across all corresponding variables in the data structure. This yields significant efficiency gains when dealing with large-scale data structures. For example, when the data structure is a 4-by-X matrix and the “X” value exceeds 1,000, the number of required modification operations decreases from 4,000 (without the disclosed approach) to 16 (using the disclosed approach). This orders-of-magnitude reduction dramatically accelerates processing and reconfiguration, especially in dynamic models or rapid reprogramming.

### Hardware Pointers-Connectivity Mesh

In some embodiments, the hardware implemented pointers disclosed herein may utilize a configurable connectivity mesh. The connectivity mesh can take on the characteristics of the connectivity meshes described in U.S. Provisional Patent Application No. 63/543,728 as filed on Oct. 11, 2023, and incorporated by reference herein in its entirety for all purposes.

The connectivity mesh may act as a configurable interconnect structure that links the outputs of a set of registers (e.g., 102) to a set of readable cells (e.g., 114). Each of the readable cells can be associated with a variable of a data structure. Each readable cell can be connected, through the connectivity mesh, to the output of the registers that holds the value of the variable. The value of the specific variable can then be retrieved by reading the content of the corresponding readable cell of the set of readable cells. This enables the disclosed system to perform parallel operations, for example, simultaneously reading the values of a vector from the data structure (e.g., a row, column, or portion of a multi-dimensional data structure), significantly accelerating data access.

In some embodiments, the connectivity mesh may be configurable, allowing the disclosed system to dynamically adjust how the registers are linked to the readable cells. This is typically accomplished using a set of programmable switches embedded in the connectivity mesh. These switches control which output of the set of registers is connected to which of the input readable cells. The switches can be configurable when the disclosed system is deployed, either post fabrication or during fabrication. The programmable switches can be controlled through the delivery of control signals to control nodes of the switches when the disclosed system has been fabricated and powered on. Alternatively, the switches can be configurable when the disclosed system is being fabricated (e.g., the integrated circuit is manufactured). For example, the switch configuration may be performed during manufacturing using techniques such as selective doping of transistors to define active connections (e.g., the controlled delivery of dopants to activate specific transistors), using customized layouts for the wiring layers of the device, or through the use of fuse or anti-fuses to create or break connections between different circuit nodes.

The configurability of the connectivity mesh can allow the disclosed system to serve as a storage structure for specific data structures, particularly in machine learning or artificial intelligence applications. By mapping model data (e.g., weights, encoded data) of an application into a customized configuration of the connectivity mesh, the disclosed system is customized to that model. The model data is typically fixed during or after training, such that a trained model can be deployed into the disclosed system to provide an efficient means for executing the model. That is, the trained model is effectively hardwired into the fabric of the disclosed system. The same system can be configured for a different trained model by simply changing the connectivity mesh of the disclosed system. The disclosed system can either reconfigure the connectivity mesh with a programmable switch or use a different metal mask or layout if the connectivity mesh is hardwired during fabrication.

In some embodiments, approaches used for mask ROM can be used to configure the connectivity mesh of the disclosed system. When building ROM through mask ROM, the contents of the memory are hard-coded during the chip fabrication process. This is done by customizing the high-level metal wiring layers on the chip to create permanent electrical connections that define which data is stored in which memory location. Similarly, the disclosed system may use different high level metal wiring masks to define how the register outputs are connected to the readable cells, thereby being customized to a specific model. Modifying a system to be used for a specific model may require saving the model in the mask ROM of the system. In this way, the model itself (e.g., a trained neural network's weights) is not stored in RAM or flash memory. Rather, the model is embedded directly into physical interconnects of hardware components. Accordingly, the disclosed system may become pre-wired to serve a specific computational model, making the disclosed system fast, efficient, and ideal for deployments where model changes are infrequent.

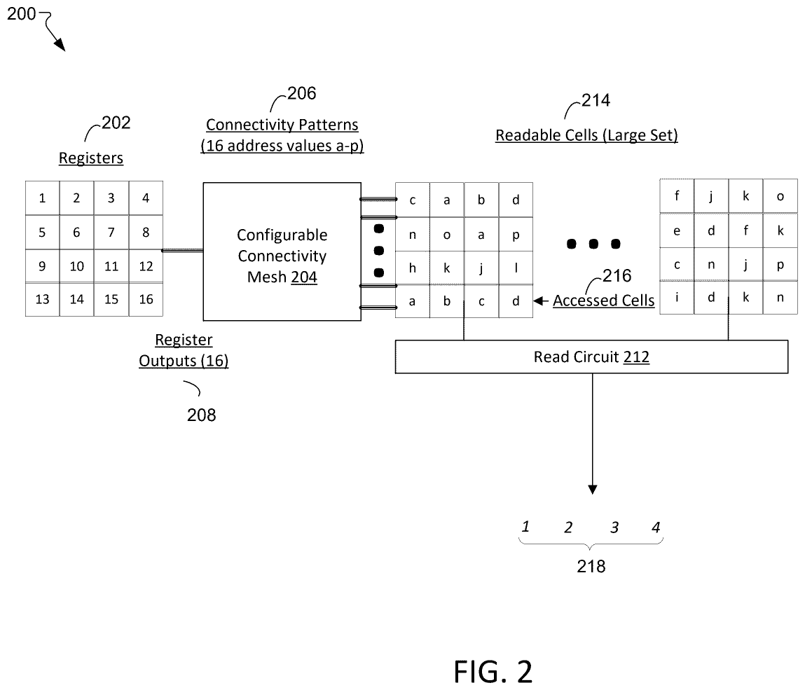

FIG. 2 illustrates an exemplary block diagram 200 of hardware pointers implemented as a configurable connectivity mesh. The hardware implemented pointers can be used to provide a code book for a large data structure in combination with a set of registers. As depicted, the disclosed system 200 includes at least a set of registers 202, a connectivity mesh 204, a read circuit 212, and a set of readable cells 214. In this example, the set of registers 202 stores 16 potential values assigned to variables of a data structure. Configurable connectivity mesh 204 connects registers 202 to the set of readable cells 214. Readable cells 214 are each connected to the registers 202 through the configurable connectivity mesh 204 such that each of the readable cells is connected to one of the 16 registers. By configuring connectivity mesh 204, the disclosed system 200 determines which register or variable value is linked to which readable cell. The mesh configuration is determined by connectivity patterns (e.g., 206), which act as a map or instruction set for establishing the connections. This enables dynamic assignment or adjustment of variable values without rewriting data in each readable cell, since only the mesh routing or connectivity patterns 206 needs to be reconfigured (e.g., connecting a cell to a different register with a new value).

Read circuit 212 is read-coupled to the set of readable cells 214 and is configured to read the values that readable cells 214 are connected to. This means that read circuit 212 effectively reads the output 208 of the corresponding register 202 through connectivity mesh 204. Read circuit 212 retrieves the effective value assigned to a variable by identifying which register 202 a given readable cell 214 is connected to. Read circuit 212 can also operate in parallel, reading multiple variable values at once.

The set of readable cells 214 can be connected, via connectivity mesh 204, to the set of registers 202 that stores the values of the variables/parameters of a data structure. In the illustrated example, each readable cell 214 is configured with a connectivity state, denoted by a symbolic value such as “a” to “p.” These connectivity states correspond one-to-one with the numerical values “1” to “16” of the register in the set of registers 202. For example, state “b” indicates that a readable cell is connected to the register with a value of “2,” state “c” connects a readable cell to the register of “3,” and so on.

In the illustrated example of FIG. 2, the set of readable cells 214 with connectivity states “a, b, c, and d” (e.g., accessed cells 216) are selected and accessed by read circuit 212. Since these states map to registers with values “1, 2, 3, and 4” respectively, read circuit 212 outputs the values “1, 2, 3, and 4” stored by the set of registers 202 in 218, as routed through the configurable connectivity mesh 204 to the set of readable cells. As illustrated, the outputs “1, 2, 3, and 4” in 218 reflect the values from the set of registers 202 to which the readable cells 214 are connected.

Using this approach and by repeatedly reading different addresses from the readable cells, the hardware implemented pointers allow for the reading of any of the values of the variables in the data structure. Moreover, the disclosed system allows for efficient updates. To modify the values of the variables in the data structure, it is only necessary to update the values stored in the set of registers 202, rather than modifying each individual readable cells 214 (i.e., changing all the values stored in the set of readable cells). For example, when the data structure is 4-by-X and the “X” value for the dimension of the matrix is greater than 1,000, there will be a total of 4,000 variables. The disclosed approach reduces the number of required modification operations from 4,000 (if each variable held a unique value) to only 16 (assuming all values are drawn from the 16 registers). This leads to a dramatic acceleration in the update process, significantly enhancing runtime efficiency and scalability.

### Registers

In some embodiments, a set of registers may output digital or analog values that represent the stored values of variables in a data structure. The analog values can be represented by different reference voltages that extend from the ground to a supply voltage. The digital values can be serialized digital signals, such as pulse trains or other digital encoding formats. For example, the set of registers can include serializers, buffers, or other circuitry that augment their ability to provide the values stored therein.

In some embodiments, when the hardware pointers are implemented by a connectivity mesh, the read circuit, which accesses values from the set of readable cells, may include a deserializer (e.g., to decode the digital signals/values received from the registers). When the hardware pointers are implemented by stored addresses, the selection circuit, which is used to route a correct register value, may include a deserializer.

The digital signals/values may be transmitted continuously or on-demand. When transmitted continuously, these digital signals flow through a configurable mesh to the readable cells, or directly from the registers to a selection circuit. As a result, the digital values are available to be read out as soon as one or more cells are accessed or a specific input to the selection circuit is selected. This can be advantageous in applications requiring low-latency access to stored values, as it eliminates the need for pre-fetching or queuing.

Alternatively, digital signals may be transmitted only when needed to reduce the unnecessary transmission of signals across the connectivity mesh. In this case, digital signals can be transmitted from the set of registers at the same time the cells are read or specific inputs to the selection circuit are selected. For example, when a read command is issued for the readable cells, this command can simultaneously trigger the set of registers to output serialized digital values. The serialized values can then be transmitted through the connectivity mesh to the readable cells and subsequently to a read circuit. Similarly, for the systems using a selection circuit, the same read command can initiate the transmission of the serialized values from the registers directly to the selection circuit, which then outputs the selected data. The on-demand signaling reduces energy consumption and improves efficiency, particularly in systems that do not require constant data availability.

In addition to the circuit used to store values, provide values to be read from, and load values into the registers, the set of registers may include ancillary circuitry. In some embodiments, the set of registers can include a set of serializers, which serializes the output values for compact and efficient transmission through the connectivity mesh to the readable cells or directly to the selection circuit. The serializers can convert stored digital values into serial data streams by serializing each digital value into a set of pulses. In the cases where analog signals are used, the serializer may convert an analog signal into a set of pulses with varying amplitudes, where each pulse encodes a multi-bit analog signal. Correspondingly, the read circuit or the selection circuit can include a set of deserializers to resolve the values read from the readable cells, i.e., to interpret the incoming serial data and reconstruct the original values.

In some embodiments, the set of registers can include a set of amplifiers to amplify the stored values for transmission through the connectivity mesh. The amplifiers, serializers, or amplifiers and serializers can be trimmed to provide the appropriate degree of amplification based on the number of readable cells connected to a given register to optimize power consumption. This architectural flexibility makes the system highly adaptable to different performance and efficiency requirements, depending on application demands.

### Data Modification

As mentioned above, the hardware implemented pointers disclosed herein allow for the efficient modification of the values of a large data structure. One notable benefit is that the modification can be achieved by altering the quantization or the bit width of the variable values without requiring to change the addressing or connectivity infrastructure.

The modifications to the large data structure can include modifying a quantization of the variables in the data structure. Quantization refers to mapping continuous or high-precision numerical values (e.g., floating point number) into a smaller and more limited set of discrete values for the purpose of improving memory efficiency, reducing computation complexity, etc. For example, the values for the variables in the data structure can be modified from a uniform quantization (also referred to as even quantization) to a biased quantization. In a uniform quantization, all variable values are spaced evenly across a defined range; however, the spacing between quantized values is nonlinear in a biased quantization, where certain value ranges are represented with greater granularity. The modifications to the large data structure can also include modifying the number of bits used to represent the variables in the data structure. For example, the values for the variables can be modified by representing the values for the variables with four bits instead of eight bits.

These modifications can be implemented merely by changing the values in a set of registers that store the values without modifying the hardware implemented pointers. For example, the configuration of the connectivity mesh or the addresses stored in the set of readable cells could remain the same while the number of bits and/or quantization used to represent the variables could be increased or decreased. This decoupling of value representation from the pointer configuration enables substantial flexibility. It allows the disclosed system to dynamically adapt to changes in precision or quantization strategy without any structural modification to the underlying memory addressing mechanism. Accordingly, a relatively low complexity connectivity mesh or a relatively small number of bits for the set of readable addresses may still suffice to represent a fixed number of potential values for the variables, but the potential values could be defined with high precision within the registers. Here, the hardware pointers (e.g., the addresses or mesh connections) act as a stable reference layer, while the actual variable values (e.g., in quantization or bit-depth) can be updated independently and efficiently via register updates.

The disclosed hardware implemented pointers enables indirect value referencing, which allows a set of readable cells (each representing a variable in a data structure) to reference values (e.g., weights, parameters used in machine learning) that are stored in a smaller set of registers. In the context of modifying quantization, the disclosed hardware implemented pointers can be used to construct a code book for the variables of a data structure, using a given bit encoding. The code book serves as a dictionary or lookup table that maps compressed, quantized, or indirect codes (e.g., e.g., 4-bit indices) into actual values (e.g., floating-point values or analog values). Here, the readable cells include the compact indirect codes, and the hardware pointers map these codes to one of the values stored in the registers. Put differently, the values stored in the registers represent entries or values in a code book, and the addresses stored in the readable cells address the entries of the code book (i.e., serves as indices to the entries). The readable cells are addressable by the read circuit via an addressing/mapping scheme. In some embodiments, the readable cells are associated with a data structure via the addressing scheme, and are read by the read circuit to retrieve the corresponding value of the data structure from the values of the codebook.

The bit encoding may represent a set of values in a range (e.g., from −2 to 2, with a 16-bit quantization of that range). However, the actual values (values referenced by that encoding) can be specified either with a high degree of particularity and a biased quantization, or with a lower degree of precision and an unbiased/even quantization. For example, the registers may initially store values corresponding to an even quantization, such as eight quanta (evenly spaced steps) of 0.5 over the range of −2 to 2. To modify the values, only the register values need to be updated. The connectivity (e.g., mesh routing or code mapping) remains unchanged, but the even quantization is changed to a biased quantization. For example, in a portion of the range in which most of the values of the variables in the data structure fell (i.e., where variable values are densely concentrated), smaller quanta (e.g., 0.10) can be used. This allows more bits to be allocated to represent values in that range region under the biased quantization than would be allocated under the even quantization.

The values in the set of registers can be selected based on the characteristics of the data structure. For example, if the data structure corresponds to a machine learning model, the quantized register values (e.g., model data or network data) can be chosen using K-means clustering or other data-driven approaches to precisely match the model data of the machine learning model with a fixed number of bits. In such cases, finer granularity (e.g., finer quanta) can be used in portions of the range where values of the variables are more densely populated, while coarser granularity (e.g., coarser quanta) is applied in other range regions. Accordingly, the average precision of the variables in the data structure could be optimized for a given bit size for the variables.

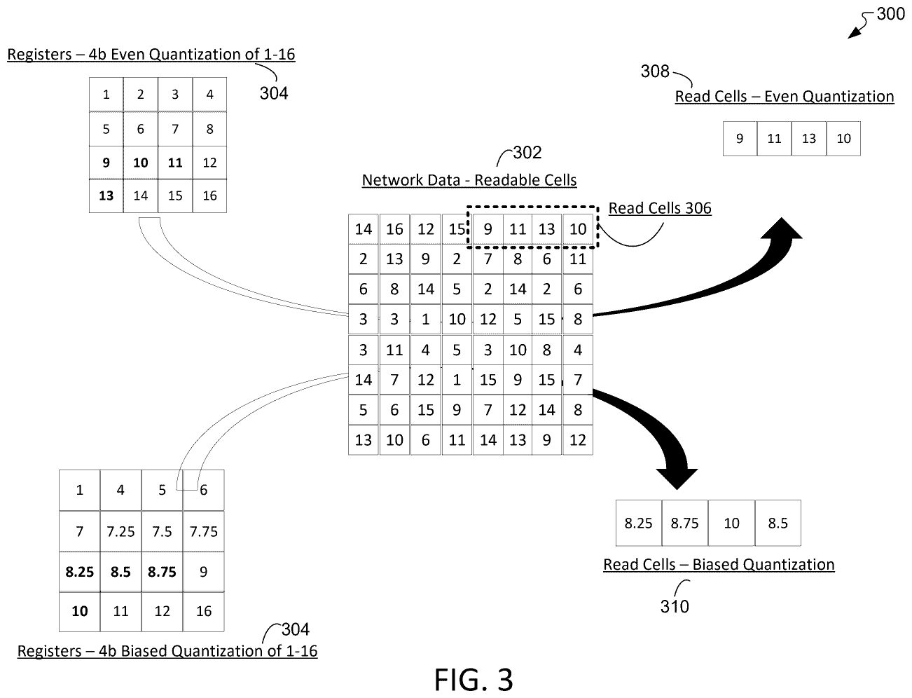

FIG. 3 is an exemplary diagram block 300 of the modification of the values of the variables in a large data structure using a different quantization. As illustrated, a data structure is illustrated by a set of readable cells 302 with each cell associated with a hardware implemented pointer. The hardware implemented pointers could be a stored address for a selection circuit or the state of a conductivity mesh. In the first example, the set of register 304 stores 4-bit numbers that evenly represent values within the range from 1-16 for the variables in the data structure. Using this encoding, the top four readable cells 306 of the set of readable cells can be accessed to obtain the values “9, 11, 13, 10” in 308 from the registers 304 via their respective hardware implemented pointers.

In contrast, in a second example, the set of registers 304 stores 8-bit floating point numbers to provide a bias quantization. This is a finer quantization for specific portions of the range of values of 1-16 for the variables in the data structure. In this case, the top four readable cells 306 of the set of readable cells can be read to retrieve the values “8.25, 8.75, 10, and 8.5” in 310 from registers 304. As can be seen, in both examples, the same hardware implemented pointers are used, but the values of the variables are represented using a finer quantization in the second example. This demonstrates how the quantization of variable values can be refined by merely changing the values stored in the registers without modifying the pointer configuration.

As stated, both the values in the set of registers and the hardware implemented pointers can be selected to provide more specific values for the variables at certain portions of the range. This is particularly beneficial in machine learning and artificial intelligence applications, where a large portion of the variables tend to cluster around certain values. Preserving higher precision between individual variables in the cluster (densely populated region) may significantly impact model performance and accuracy. Thus, it is important to have circuitry that is capable of flexibly storing data structures with varying levels of quantization and precision.

### Flow Chart

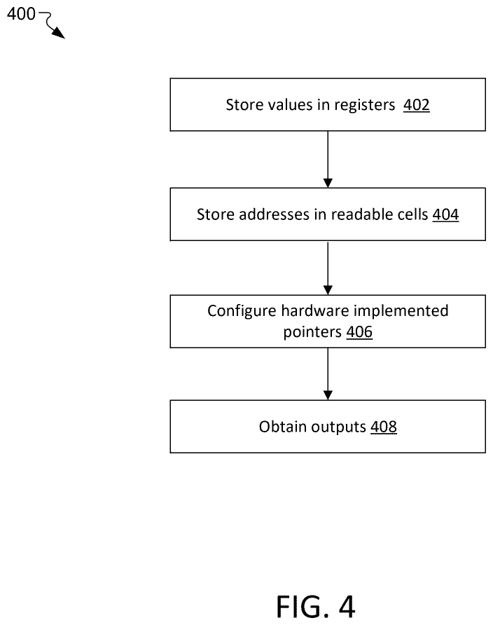

FIG. 4 illustrates a flow diagram 400 for storing variables of a large data structure using hardware implemented pointers, according to some embodiments. Flow diagram 400 starts with storing a set of values in a set of registers at step 402. At step 404, a set of addresses is stored in a set of readable cells. At step 406, a set of hardware implemented pointers is configured to function as a code book to map the set of registers to the set of readable cells. At step 408, the set of readable cells is accessed using a read circuit to obtain a set of outputs from the set of registers through the set of hardware implemented pointers.

In some embodiments, the set of hardware implemented pointers is implemented using a configurable connectivity mesh or the set of addresses stored in the set of readable cells. If the hardware implemented pointers is in the form of the set of addresses stored in the set of readable cells (as shown in FIG. 1), a selection circuit that is input-coupled to the set of registers and control-coupled to the read circuit may be used to provide the set of outputs, where these outputs include the values stored in the set of registers and retrieved by the read circuit based on the set of addresses. If the hardware implemented pointers are implemented through the configurable connectivity mesh (as shown in FIG. 2), the set of outputs is provided using the set of values as provided from the set of registers to the set of readable cells via the configurable connectivity mesh.

In some embodiments, the set of registers may store the values of a set of variables in a large data structure, and the pointers can identify the value of each variable by referencing the appropriate registers in the set of registers that store those values. The pointers can be arranged either physically or logically in accordance with the data structure, allowing the values of the data structure to be accessed using the hardware implemented pointers.

The variables in the data structure can be modified based on a modification of the set of values in the set of registers without changing an addressing scheme or connectivity infrastructure. In some embodiments, modifying the set of values in the set of registers can alter a quantization, numerical or logical values, a resolution, and/or a data type for the set of variables.

### Additional Considerations

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to machine intelligence applications, the same approaches could be utilized to other computationally intensive applications including cryptographic computations, ray tracing computations, and others. As another example, although examples in the disclosure were generally directed to computations in which multiplication operations must be conducted on a data structure with a number of parameters that is much larger than the potential values of those parameters, the same approaches can be used for different operations in place of the multiplication such as division, subtraction, addition, roots, logarithms, exponents, factorials, and any other mathematical or logical operation. These and other modifications and variations to the present invention may be practiced by those skilled in the art, without departing from the scope of the present invention, which is more particularly set forth in the appended claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/of” should be construed in the same fashion, i.e., “one or more” of the elements so conjoined. Other elements may optionally be present other than the elements specifically identified by the “and/of” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A system comprising:
a set of registers storing a set of values;
a set of readable cells storing a set of addresses;
a read circuit that is read-coupled to the set of readable cells; and
a selection circuit that is input-coupled to the set of registers, control-coupled to the read circuit, and configured to provide a set of outputs using the set of values from the set of registers based on the set of addresses read from the read circuit.

2. The system of claim 1, wherein:
the set of readable cells are addressable by the read circuit via an addressing scheme, and
the set of readable cells are read by the read circuit, via the addressing scheme, to retrieve a value of a data structure from the set of values associated with the data structure.

3. The system of claim 2, wherein the set of values associated with the data structure is programmable by setting the set of values in the set of registers.

4. The system of claim 2, wherein the data structure is programmable by programming the set of addresses.

5. The system of claim 2, wherein the selection circuit comprises one or more multiplexers.

6. A system comprising:
a set of registers storing a set of values;
a set of readable cells;
a configurable connectivity mesh coupling the set of registers to the set of readable cells;
a read circuit that is read-coupled to the set of readable cells and configured to provide a set of outputs using the set of values as provided from the set of registers to the set of readable cells via the configurable connectivity mesh.

7. The system of claim 6, wherein:
the configurable connectivity mesh connects the set of registers to the set of readable cells via an addressing scheme, and
the set of readable cells are read by the read circuit, via the addressing scheme, to retrieve a value of a data structure from the set of values associated with the data structure.

8. The system of claim 7, wherein the set of values associated with the data structure is programmable by setting the set of values in the set of registers.

9. The system of claim 7, wherein:
the data structure is programmable by configuring the configurable connectivity mesh with the addressing scheme.

10. A method comprising:
storing a set of values in a set of registers;
storing a set of addresses in a set of readable cells;
configuring a set of hardware implemented pointers to map the set of registers to the set of readable cells;
reading the set of readable cells using a read circuit to obtain a set of outputs from the set of registers through the set of hardware implemented pointers.

11. The method of claim 10, wherein the set of hardware implemented pointers is implemented using a configurable connectivity mesh or the set of addresses stored in the set of readable cells.

12. The method of claim 11, wherein, when the set of hardware implemented pointers is implemented using the set of addresses stored in the set of readable cells, the set of outputs is provided by a selection circuit that is input-coupled to the set of registers and control-coupled to the read circuit based on the set of addresses.

13. The method of claim 11, wherein, when the set of hardware implemented pointers is implemented using the configurable connectivity mesh, the set of outputs is provided using the set of values as provided from the set of registers to the set of readable cells via the configurable connectivity mesh.

14. The method of claim 10, wherein:
the set of registers stores values of a set of variables in a data structure, and
the hardware implemented pointers identify a value of each variable by referencing appropriate registers in the set of registers that store those values.

15. The method of claim 14, further comprising modifying the set of values in the set of registers to alter a quantization for the set of variables.

16. The method of claim 14, further comprising modifying the set of values in the set of registers to alter numerical or logical values of the set of variables.

17. The method of claim 14, further comprising modifying the set of values in the set of registers to alter a resolution of the set of variables.

18. The method of claim 14, further comprising modifying the set of values in the set of registers to alter a data type used to represent the set of variables.

19. The method of claim 14, wherein the set of variables in the data structure is modified based on a modification of the set of values in the set of registers without changing an addressing scheme or a connectivity infrastructure.

20. The method of claim 14, wherein the set of hardware implemented pointers is arranged physically or logically in accordance with the data structure to enable access of the set of variables in the data structure.
